(19) United States
(12) Patent Application Publication
(10) Pub. No.: US 2026/0056688 A1
(43) Pub. Date: Feb. 26, 2026

(54) IMAGE FORMING APPARATUS AND IMAGE PROCESSING METHOD

(71) Applicant: CANON KABUSHIKI KAISHA, Tokyo (JP)

(72) Inventors: TAKUMI KIMURA, Chiba (JP); MICHIHIKO YAMADA, Ibaraki (JP); YUKIHIRO SHINDO, Chiba (JP); HIDEKAZU NAKASHIO, Saitama (JP); YUKI NAKATANI, Chiba (JP)

(21) Appl. No.: 19/301,744

(22) Filed: Aug. 15, 2025

(30) Foreign Application Priority Data
Aug. 20, 2024 (JP) 2024-139289

(51) Int. Cl. G06F 3/12; G06K 15/02; G06K 15/14

(52) U.S. Cl. CPC G06F 3/1219; G06K 15/1823; G06K 15/14

(57) ABSTRACT

An image forming apparatus includes a printer, at least one memory storing a program, and at least one processor that, upon execution of the program is configured to acquire an attention level in an area of an image based on image data, the attention level being estimated through machine learning, perform image processing on the image data based on the estimated attention level so that an amount of recording material to be used to draw an area with a low attention level in the image is less than an amount of recording material to be used to draw an area with a high attention level in the image, and cause the printer to print the image on a printing medium based on the image data having been subjected to the image processing.

### BACKGROUND

### Field of the Technology

The present disclosure relates to an image forming apparatus and an image processing method.

### Description of the Related Art

Japanese Patent Application Laid-Open No. 2018-006982 is known as a technique for reducing the amount of recording material to be used for printing.

Japanese Patent Application Laid-Open No. 2018-006982 describes a technique for analyzing, in photo images captured by a plurality of cameras, distance information attached to the photo images based on the principle of the trigonometrical measurement, and reducing the toner consumption in defocused areas.

For example, in printing a photo image of a flower garden, the use of the method discussed in Japanese Patent Application Laid-Open No. 2018-006982 may be unsuitable. Suppose the photo image depicts not only the sky but also a plurality of flowers and soil. Furthermore, in this photo image, one flower, which is the main subject, is in focus, while the other flowers are out of focus, yet their blurred colors contribute to the aesthetic appeal. In other words, regardless of whether the flowers are in focus, they attract a high level of attention, whereas the sky and soil are relatively less prominent.

The method described in Japanese Patent Application Laid-Open No. 2018-006982 reduces the toner consumption in defocused areas (objects). As a result, even flowers that are out of focus, despite being one of the elements contributing to the aesthetic appeal, are subject to reduction of toner consumption.

### SUMMARY

According to an aspect of the present disclosure, an image forming apparatus includes a printer, at least one memory storing a program, and at least one processor that, upon execution of the program is configured to acquire an attention level in an area of an image based on image data, the attention level being estimated through machine learning, perform image processing on the image data based on the estimated attention level so that an amount of recording material to be used to draw an area with a low attention level in the image is less than an amount of recording material to be used to draw an area with a high attention level in the image, and cause the printer to print the image on a printing medium based on the image data having been subjected to the image processing.

Features of the present disclosure will become apparent from the following description of embodiments with reference to the attached drawings. The following description of embodiments is described by way of example.

### BRIEF DESCRIPTION OF THE DRAWINGS

FIG. 1 illustrates an example of a hardware configuration of an image processing apparatus according to a first exemplary embodiment.

FIG. 2 illustrates an example of a logical configuration of the image processing apparatus according to the first exemplary embodiment.

FIG. 3 is a flowchart illustrating an example of toner saving processing according to the first exemplary embodiment.

FIG. 4 illustrates examples of photo images represented by image data according to the first exemplary embodiment.

FIG. 5 illustrates examples of pieces of semantic label information according to the first exemplary embodiment.

FIG. 6 illustrates examples of pieces of saliency information according to the first exemplary embodiment.

FIG. 7 illustrates examples of toner reduction areas according to the first exemplary embodiment.

FIGS. 8A to 8C illustrate examples of color conversion Look-Up Tables (LUTs) according to the first exemplary embodiment.

FIG. 9 illustrates examples of density adjustments according to the first exemplary embodiment.

FIG. 10 is a flowchart illustrating an example of toner saving processing according to a second exemplary embodiment.

FIG. 11 illustrates an example of a buffer area according to the second exemplary embodiment.

FIGS. 12A and 12B illustrate examples of print setting screens according to the second exemplary embodiment.

### DESCRIPTION OF THE EMBODIMENTS

Exemplary embodiments for carrying out the present disclosure will be described below with reference to the accompanying drawings. It should be noted that the following exemplary embodiments are not intended to limit the disclosure as defined in the claims. Although a plurality of features are described in the exemplary embodiments, not all of these features are necessarily essential to the disclosure, and they may be combined in any suitable manner.

### First Exemplary Embodiment

### <Hardware Configuration of Image Processing Apparatus 100>

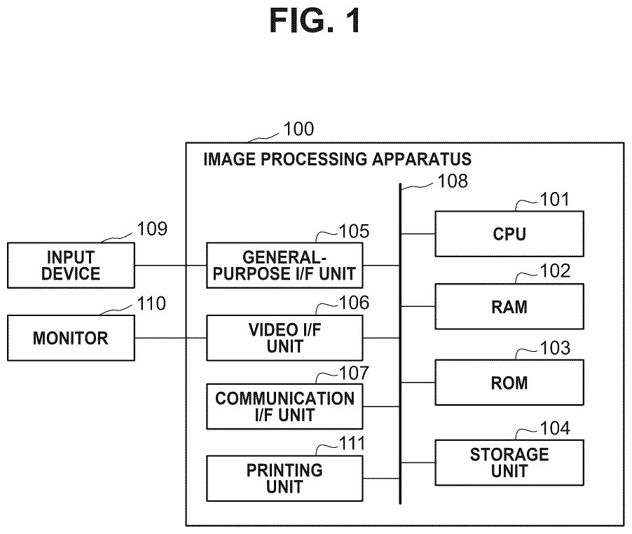

FIG. 1 illustrates a hardware configuration of an image processing apparatus 100 according to a first exemplary embodiment.

The image processing apparatus 100 includes a Central Processing Unit (CPU) 101, a Random Access Memory (RAM) 102, a Read Only Memory (ROM) 103, a storage unit 104, a general-purpose interface (I/F) unit 105, a video I/F unit 106, a communication I/F unit 107, and a printing unit 111. These units are connected via an internal system bus 108 and are capable of communicating with each other.

The CPU 101 reads a main program from the storage unit 104 according to the initial program in the storage unit 104 and stores the main program in the RAM 102. The RAM 102 is used as a main memory for storing programs and for use as a working memory. The ROM 103 is used to temporarily store data generated during program processing. The storage unit 104 is used to store data such as programs, image data, and look-up tables (hereinafter referred to as LUTs).

The general-purpose I/F unit 105 is a serial device interface such as a Universal Serial Bus (USB) and is connected to an input device 109 for inputting user instructions, such as a keyboard and a mouse. The video I/F unit 106 is connected to a monitor 110. The communication I/F unit 107 is used to perform communication via a network. The printing unit 111 is, for example, a printer used to print an image based on image data on a printing medium.

The input device 109 according to the present exemplary embodiment is an example of a reception unit for accepting various inputs and settings from the user.

The image processing apparatus 100 is an example of an image forming apparatus which may be a printing apparatus such as a Multi-Function Peripheral (MFP) or a printer.

### <Logical Configuration of Image Processing Apparatus 100>

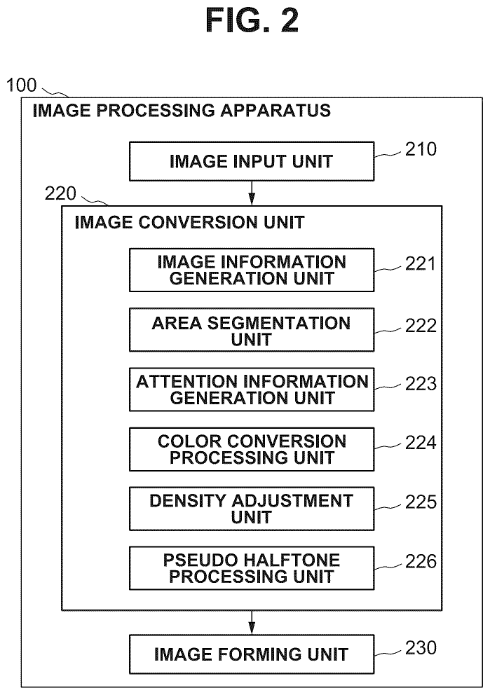

FIG. 2 illustrates a logical configuration of the image processing apparatus 100 according to the present exemplary embodiment.

The image processing apparatus 100 includes an image input unit 210, an image conversion unit 220, and an image forming unit 230. In addition to the image input unit 210, the image conversion unit 220, and the image forming unit 230, the CPU 101 controls each unit of the image conversion unit 220 to execute the corresponding functions.

The image input unit 210 inputs image data. Examples of image input methods include a method for inputting image data through an application, such as a printer driver, on a personal computer (PC) connected to the image processing apparatus 100, a method for acquiring image data by scanning an image with a scanner unit, and a method for receiving image data via a network.

The image conversion unit 220 includes an image information generation unit 221, an area segmentation unit 222, an attention information generation unit 223, a color conversion processing unit 224, a density adjustment unit 225, and a pseudo halftone processing unit 226. The image conversion unit 220 converts data transmitted from the image input unit 210 into a printing image.

The image information generation unit 221 subjects the data transmitted from the image input unit 210 to image processing to generate image information so that graphics, texts, and photo images can be distinguished on an object basis.

If the data transmitted from the image input unit 210 is attached with no object information, the CPU 101 detects edges in the image data of the image, and checks the continuity of the edges to identify graphic, text, and photo image areas.

The area segmentation unit 222 subjects the photo image areas identified by the image information generation unit 221 to semantic area division processing (panoptic segmentation) by using a pre-trained classifier to calculate semantic label information for each pixel.

A pre-trained classifier can be obtained, for example, by using machine learning-based models such as SegNet or U-Net, particularly those based on convolutional neural networks (CNNs), and training them in advance using pairs of images and corresponding semantic ground truth labels. In the present exemplary embodiment, a machine-learning-based classifier is used; however, as long as semantic segmentation is achievable, other methods such as rule-based approaches, such as active contour models (snakes) or level set methods, may also be used. In addition, a combination of machine learning and a rule-based method is also applicable.

The attention information generation unit 223 subjects the photo image areas identified by the image information generation unit 221 to saliency inference by using a pre-trained inference model to calculate the saliency for each pixel. According to the present exemplary embodiment, the saliency refers to the degree of tendency of a person to pay attention to an image. The saliency, which is an example of an attention level, increases with increasing numeric value. For example, in a case where a high-luminance object is present on a low-luminance background, the saliency of the high-luminance object is high.

In a case where a high-luminance object and a low-luminance object are present on a high-luminance background, the saliency of the high-luminance object is relatively lower than the saliency of the low-luminance object. Similarly, in a case where a green object and an orange object are present on a red background, the saliency of the green object, which has the complementary color of red, is relatively higher than the saliency of the orange object. Thus, the saliency in a still image is determined based on the spatial arrangement of visual stimulation, such as luminance or color.

In a case where a moving object and a still object are present in a moving image, the saliency of the moving object is relatively higher than the saliency of the still object. As described above, the saliency in a moving image is determined not only based on the spatial arrangement of visual stimulation but also on the change of visual stimulation over time.

For example, a pre-trained inference model can be obtained through the pre-learning of a machine-learning (particularly CNN)-based machine learning model such as SalNet and SalGAN, with a pair of an input image and a saliency map for the input image. In this case, the saliency map is generated by measuring the eye movements of test subjects while they freely observes an image displayed on a monitor for several seconds. For example, using the above-described methods enables estimating the attention level of image data through machine learning. More specifically, the attention level is estimated by using some or all of these calculations.

Although the present exemplary embodiment uses a machine-learning-based inference model, a rule-based method is also applicable as long as the saliency inference is possible. Rule-based methods are known techniques based on cognitive mechanisms and make it possible to perform the saliency inference based on the Feature Integration Theory. The Feature Integration Theory proposes that the image on the human visual field is parallelly processed for each feature (luminance, color, and gradient) and these features are ultimately integrated.

With the Feature Integration Theory, the attention information generation unit 223 calculates image features (luminance, color, and gradient) of an image, and calculates the saliency for each image feature. The CPU 101 integrates the saliency of these image features to calculate the saliency for each pixel.

For example, luminance distribution information I, red-green contrast information RG, and blue-yellow contrast information BY are extracted from an input image, and gradient information for 0, 45, 90, and 135 degrees are extracted from the input image by using a Gabor filter. For each piece of extracted information, the feature quantities of the luminance, color, and gradient are calculated by using a Difference of Gaussian filter, and then the feature quantities are normalized. A linear sum of the calculated feature quantities are obtained, thus calculating the saliency.

Examples of other rule-based saliency inference methods include a method for performing a logarithmic spectrum analysis. This method calculates the logarithmic spectrum of an input image, extracts the residual between the calculated logarithmic spectrum and a logarithmic spectrum as a result of smoothing the calculated logarithmic spectrum, and converts the spectrum residual into a spatial domain to calculate the saliency.

The color conversion processing unit 224 converts the image data transmitted from the image input unit 210 into data suitable for the target image processing apparatus. For example, if Red-Green-Blue (RGB) data is input, and the image processing apparatus is a color printer that uses standard Cyan-Magenta-Yellow-Black (CMYK) toner, the color conversion processing unit 224 converts the data by using a color conversion table (LUT).

A three-dimensional LUT, which is one of representative color conversion processing methods, is used as the color conversion LUT. This method is based on a search table representing the correspondence for converting RGB data into CMYK data. The search table includes N×N×N grid points, theoretically, color conversion can be accurately performed by sufficiently narrowing the grid intervals. However, in practice, due to limitations such as memory capacity and processing speed, it is extremely rare for the color conversion point to coincide exactly with a grid point. Thus, CMYK values are obtained through three-dimensional interpolation processing.

Here, RGB is called three primary colors of light. RGB data is used for light emission methods for display. CMYK is called process colors. CMYK data is used for printing on paper.

The density adjustment unit 225 subjects data processed by the color conversion processing unit 224 to density adjustment. For example, if CMYK signal values are processed by the color conversion processing unit 224, the CPU 101 adjusts the signal values of single colors (C, M, Y, and K) to adjust the density. In other words, the CPU 101 adjusts the density by adjusting the signal values of single colors.

The pseudo halftone processing unit 226 subjects the data processed by the density adjustment unit 225 to pseudo halftone processing by using the density pattern method, systematic dither method, and error diffusion method.

The image forming unit 230 receives the printing image generated by the image conversion unit 220 and performs image formation on a printing medium by using a recording material such as toner.

### <Toner Saving Processing>

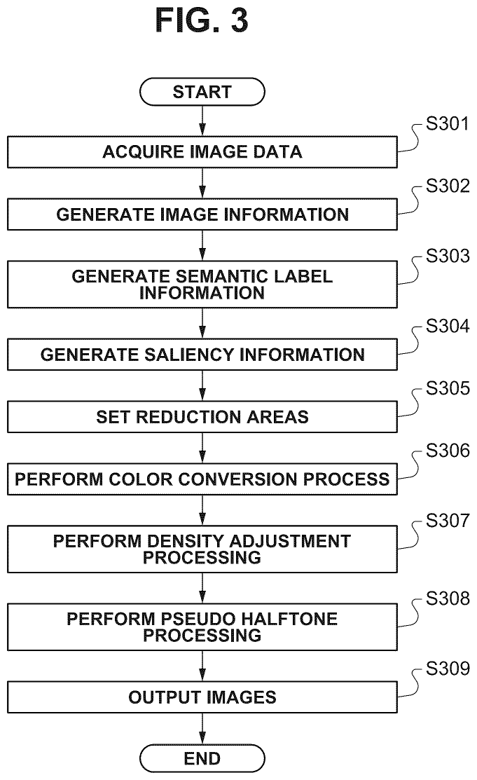

FIG. 3 is a flowchart illustrating operations of the image processing apparatus 100 to subject the photo image areas of the input image data to toner saving processing and then output images on a recording medium. This processing enables efficient reduction of toner consumption without compromising print quality.

Each piece of processing in FIG. 3 is implemented when the CPU 101 loads program codes stored in the ROM 103 into the RAM 102, and reads and executes the program codes loaded into the RAM 102. This processing is started, for example, when the user inputs an execution instruction via the input device 109 of the image processing apparatus 100. In addition to the image input unit 210, the image conversion unit 220, and the image forming unit 230, the CPU 101 controls each unit of the image conversion unit 220 to execute the corresponding function.

In step S301, the image input unit 210 controlled by the CPU 101 acquires image data. Examples of methods for acquiring image data include a method for acquiring image data stored in the storage unit 104 through a user's specification, and a method for receiving image data via the communication I/F unit 107. If the image processing apparatus 100 includes a reading unit or a scanner, image data may be obtained by reading a document via the reading unit or the scanner.

In step S302, the image information generation unit 221 controlled by the CPU 101 processes the image data acquired by the CPU 101 in step S301 to generate image information distinguished on an object basis.

If image data is acquired from a printer driver in step S301, the image data is described with a page description language (PDL), and bitmap image data may be rendered from the PDL data. In this case, object information is appended to the PDL data.

In step S303, based on the image information generated in step S302, the area segmentation unit 222 controlled by the CPU 101 calculates semantic label information for each pixel using a pre-trained classifier for each photo image area of the bitmap image data. In this case, the area segmentation unit 222 calculates the semantic label information by subjecting each photo image area to panoptic segmentation.

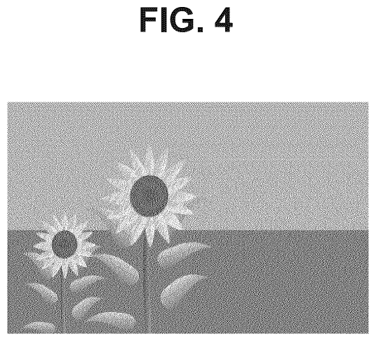

FIG. 4 illustrates examples of a photo image area of the bitmap image data acquired by the image input unit 210 in step S301.

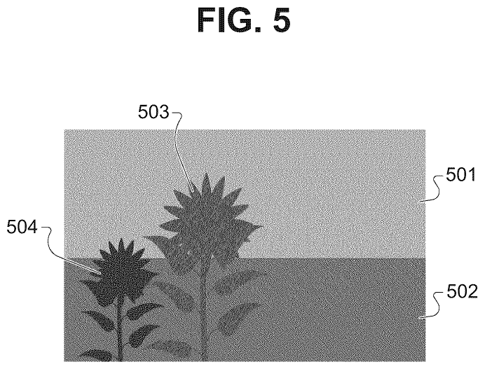

FIG. 5 illustrates examples of pieces of semantic label information for the photo image area in FIG. 4, generated by the area segmentation unit 222 in step 303. The area segmentation unit 222 calculates four different pieces of semantic label information 501, 502, 503, and 504.

Although, in the present exemplary embodiment, semantic label information is calculated through panoptic segmentation, the semantic label information may be calculated by using semantic segmentation or instance segmentation.

In step S304, based on the image information generated in step S302, the attention information generation unit 223 controlled by the CPU 101 subjects each photo image area of the bitmap image data to saliency inference by using a pre-trained inference model to calculate saliency information for each pixel.

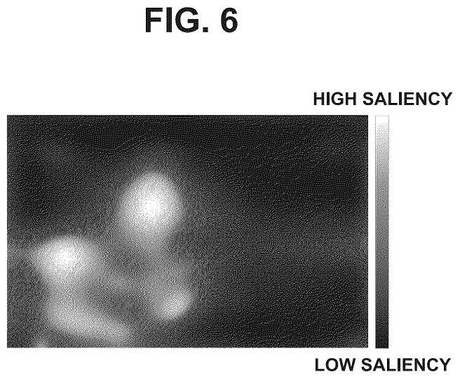

FIG. 6 illustrates an example the saliency information calculated by the attention information generation unit 223. In this example, a darker portion represents a pixel having lower saliency. In this case, the saliency information is normalized to 0 to 1.

In step S305, the area segmentation unit 222 controlled by the CPU 101 sets a toner reduction area by using the semantic label information calculated in step S303 and the saliency information calculated in step S304.

The area segmentation unit 222 performs determination for all pixels and sets, based on the average saliency of pixels assigned the same semantic label information, areas with average saliency lower than a predetermined threshold as high toner reduction areas, and areas with average saliency equal to or greater than the predetermined threshold as low toner reduction areas.

For example, a pixel with semantic label information 501 provides average saliency of 0.2, a pixel with semantic label information 502 provides average saliency of 0.4, a pixel with semantic label information 503 provides average saliency of 0.9, and a pixel with semantic label information 504 provides average saliency of 0.8. A threshold for setting a high toner reduction area is 0.7.

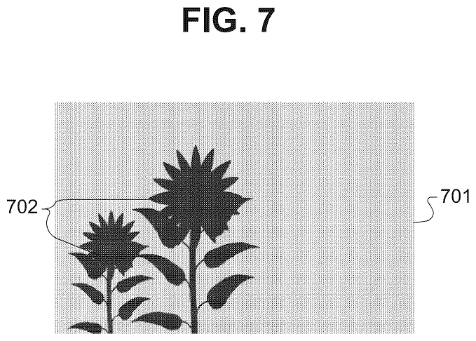

As illustrated in FIG. 7, the area segmentation unit 222 sets a pixel with the semantic label information 501 or 502 as a high toner reduction area 701, and a pixel with the semantic label information 503 or 504 as a low toner reduction area 702. According to the present exemplary embodiment, the area segmentation unit 222 sets a high toner reduction area based on the average saliency of pixels assigned the same semantic label information. However, the area segmentation unit 222 may set a high toner reduction area based on other statistical measures, such as the minimum value, maximum value, median, percentile values.

According to the present exemplary embodiment, the area segmentation unit 222 sets a high toner reduction area based on the average saliency of pixels assigned the same semantic label information. However, the area segmentation unit 222 may set a high toner reduction area based on a combination of the average saliency and area information. In this case, for example, the area segmentation unit 222 may also set, as a high toner reduction area, an area that has the value of (average saliency+number of pixels having the same semantic label information/total number of pixels)/2 is less than a predetermined threshold, and set, as a low toner reduction area, an area that has the value of (average saliency+number of pixels having the same semantic label information/total number of pixels)/2 is equal to or larger than the predetermined threshold value.

In step S306, referring to the color conversion LUT, the color conversion processing unit 224 controlled by the CPU 101 performs the color conversion so that the amount of toner used to draw the high toner reduction area 701 set in step S305 is less than the amount of toner used to draw the low toner reduction areas 702 set in step S305.

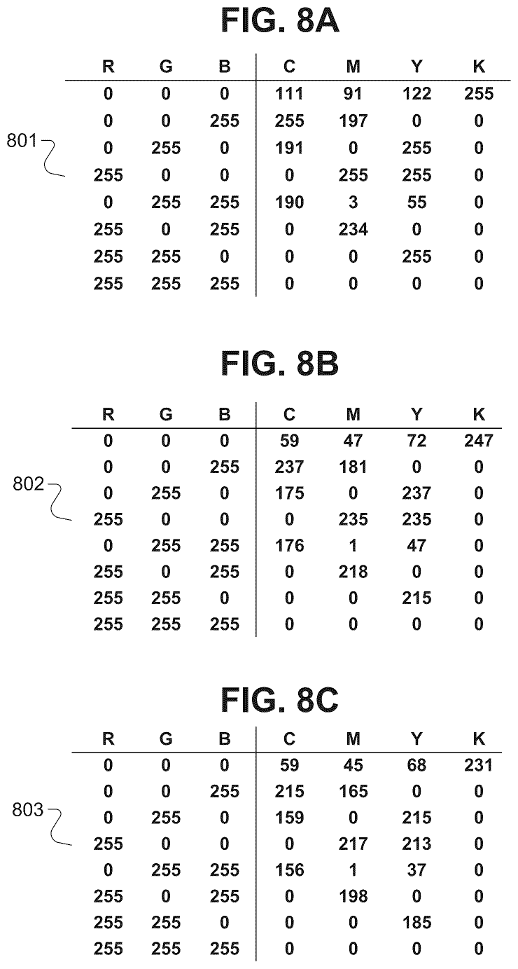

FIGS. 8A to 8C illustrate examples of color conversion LUTs stored in the storage unit 104 according to the present exemplary embodiment.

FIG. 8A illustrates a normal color conversion LUT 801. FIG. 8B illustrates a low toner reduction color conversion LUT 802. FIG. 8C illustrates a high toner reduction color conversion LUT 803. The toner consumption decreases in order of the normal color conversion LUT 801, the low toner reduction color conversion LUT 802, and the high toner reduction color conversion LUT 803.

Referring to the low toner reduction color conversion LUT 802, the color conversion processing unit 224 subjects the RGB values stored in each pixel of the low toner reduction areas 702 set in step S305 to color conversion processing into the CMYK values. Referring to the high toner reduction color conversion LUT 803, the color conversion processing unit 224 subjects the RGB values stored in each pixel of the high toner reduction area 701 set in step S305 to the color conversion processing to convert the RGB values into the CMYK values.

Here, the low toner reduction color conversion LUT 802 and the high toner reduction color conversion LUT 803 are generated by searching for the CMYK values that can reduce the toner consumption with a constant color difference from L*a*b* represented by the CMYK values of the normal color conversion LUT 801.

For example, assume that CMYK=(255, 197, 0, 0) of the normal color conversion LUT 801 represents L*a*b*=(28.7, 7.4, −45.7) (not illustrated). In this case, when the CMYK values that can reduce the toner consumption within a color difference of 3.2 or less are searched for, CMYK=(237, 181, 0, 0) and L*a*b*=(33.0, 7.1, −43.8) are found.

If a plurality of candidates is found, for example, the color conversion processing unit 224 selects a candidate that is most likely to maintain the hue from the top 5% candidates largely reducing the toner consumption, thus selecting the CMYK values that can reduce the toner consumption without degrading the impression. The above-described search processing also includes Under Color Removal (UCR) processing for reducing the toner consumption by replacing C, M, or Y with K.

The color conversion processing unit 224 may also change the color conversion LUT even in the same toner reduction area. For example, the color conversion processing unit 224 subjects only the high frequency portion in the high toner reduction area 701 to the color conversion referring to a color conversion LUT having a larger UCR amount than that of the high toner reduction color conversion LUT 803. This can reduce the toner consumption while preventing the print quality degradation by using the spatial frequency characteristics of the human eyes.

In the present exemplary embodiment, the color conversion processing unit 224 subjects the low toner reduction areas 702 to the color conversion by using the low toner reduction color conversion LUT 802; however, the color conversion processing unit 224 may perform the color conversion by using the normal color conversion LUT 801. The present exemplary embodiment is not limited to these methods as long as the amount of toner used to print (draw) the high toner reduction area 701 can be made less than the amount of toner used to print (draw) the low toner reduction areas 702.

In step S307, the density adjustment unit 225 controlled by the CPU 101 adjusts the CMYK signal values obtained in step S306 to adjust the density so that the amount of toner to be used to draw the high toner reduction area 701 is less than the amount of toner to be used to draw the low toner reduction areas 702.

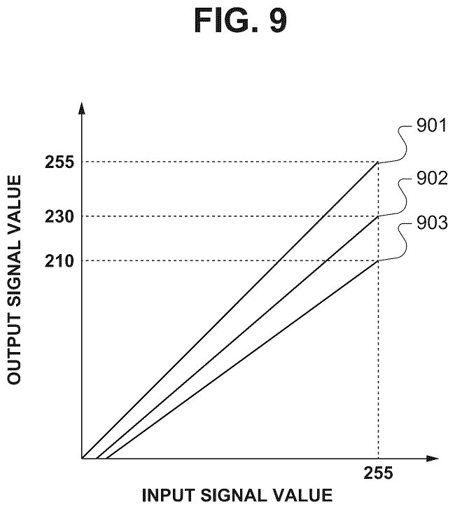

FIG. 9 illustrates examples of the density adjustments. Of density adjustments 901 to 903, the density adjustment 901 indicates a state where density adjustment is not performed. The toner reduction amount increases and hence the toner consumption in printing decreases in order of the density adjustment 903, the density adjustment 902, and the density adjustment 901.

The density adjustment unit 225 controlled by the CPU 101 subjects the low toner reduction areas 702 to the adjustment of the CMYK signal values so that the relation between the input and the output signal values indicated by the density adjustment 902 is obtained. The density adjustment unit 225 subjects the high toner reduction area 701 to the adjustment of the CMYK signal values so that the relation between the input and the output signal values indicated by the density adjustment 903 is obtained.

Although, in the present exemplary embodiment, the density adjustment unit 225 subjects the low toner reduction areas 702 to the adjustment of the CMYK signal values so that the input signal value indicated by the density adjustment 902 is obtained, the density adjustment unit 225 may aim for the input signal value indicated by the density adjustment 901. Any other methods are also applicable as long as the amount of toner to be used to draw the high toner reduction area 701 is less than the amount of toner to be used to draw the low toner reduction areas 702.

In step S308, the pseudo halftone processing unit 226 controlled by the CPU 101 performs, using the CMYK signal values obtained in step S307, the pseudo halftone processing so that the amount of toner to be used for the high toner reduction area 701 is less than the amount of toner used for the low toner reduction areas 702.

The pseudo halftone processing unit 226 performs high screen ruling processing on the high toner reduction area 701, and low screen ruling processing, with a screen ruling lower than that used for the low toner reduction area 702. After the screen processing, the pseudo halftone processing unit 226 may perform thinning processing with a larger thinning amount than that for the high toner reduction area 701 and perform thinning processing with a smaller thinning amount than that for the low toner reduction areas 702, thus reducing the toner consumption. The method for reducing the toner consumption is not limited as long as the amount of toner used to draw the high toner reduction area 701 is less than the amount of toner used to draw the low toner reduction areas 702.

In step S309, the image forming unit 230 controlled by the CPU 101 forms (prints) images on a printing medium by using a recording material such as toner based on the adjustments made in the preceding steps. More specifically, the amount of toner to be used to print the high toner reduction area 701 is less than the amount of toner to be used to print the low toner reduction areas 702. When printing is completed, the processing in step S309 is ended and the process of this flowchart is also ended.

Thus, the description has been provided of the process in the present disclosure, in which the amount of toner used to draw the high toner reduction area 701 is made less than the amount of toner used to draw the low toner reduction areas 702. The high and low toner reduction areas 701 and 702 are set by subjecting the photo image areas with large toner consumption to panoptic segmentation and saliency inference. This is because, when an image undergoes degradation in a highly salient area and another image undergoes degradation of the same degree in a less salient area, humans tend to perceive the former as more severely deteriorated in terms of impression.

In the above descriptions, as a method for reducing the toner consumption, color hue preservation during normal printing (step S306), gradation preservation (step S307), and color conversion utilizing the spatial frequency characteristics of human vision (step S306) are performed. These processes enable efficient reduction of the toner consumption while preventing the print quality degradation.

In the above-described examples according to the present exemplary embodiment, the CPU 101 performs different color conversion processing, density adjustment processing, and pseudo halftone processing as image processing suitable for each of the high and the low toner reduction areas 701 and 702. However, these pieces of processing do not necessarily need to be different between the two areas. For example, the color conversion processing may be commonly applied, and only the density adjustment processing and pseudo-halftone processing may be performed differently, as in steps S307 and S308. Alternatively, the pseudo-halftone processing and density adjustment processing may be commonly applied, and only the color conversion processing may be performed differently, as in step S306.

According to the present exemplary embodiment, an example has been presented in which an image is segmented into high and low toner reduction areas, and different color conversion processing, density adjustment processing, and pseudo-halftone processing are performed. However, the color conversion processing, density adjustment, and/or pseudo halftone processing according to the average saliency of pixels with the same semantic label information may be performed.

In this case, in step S305, the area segmentation unit 222 sets pixels assigned the same semantic label information as a plurality of toner reduction areas, instead of segmenting the image into two different areas, specifically, high and low toner reduction areas, and calculates the average saliency for each toner reduction area.

In step S306, the color conversion processing unit 224 controlled by the CPU 101 generates a color conversion LUT as follows according to the average saliency for each toner reduction area, and performs the color conversion for each toner reduction area.

$$New color conversion LUT = Low toner reduction color conversion LUT 802 \times Average saliency + High toner reduction color conversion LUT 803 \times ( 1 - Average saliency )$$

In step S307, the density adjustment unit 225 controlled by the CPU 101 adjusts the CMYK signal values to achieve the following relation between the input and the output signal values according to the average saliency for each toner reduction area.

$$New density adjustment = Density adjustment 902 \times Average saliency + Density adjustment 903 \times ( 1 - Average saliency )$$

In step S308, the pseudo halftone processing unit 226 controlled by the CPU 101 performs the pseudo halftone processing based on the following thinning amount calculated from predetermined low and high thinning amounts according to the average saliency for each toner reduction area.

$$New thinning amount = Low thinning amount \times Average saliency + High thinning amount \times ( 1 - Average saliency )$$

According to the present exemplary embodiment, saliency inference is performed for each photo image area of the input image data in the saliency inference in step S304. However, the processing may be performed on a plurality of photo image areas of the input image data at the same time. This is because saliency is a relative measure, and an area with high saliency in one image (image 1) may appear relatively less salient when viewed, at the same time, with another image (image 2) that contains areas with even higher saliency. Thus, within the input image data, areas with relatively high saliency can be set as low toner reduction areas, while areas with relatively low saliency can be set as high toner reduction areas, thus enabling efficient reduction of toner consumption.

In the present exemplary embodiment, descriptions have been provided of toner saving processing for the photo image areas. However, graphic areas may be subjected to similar processing or known toner saving processing. Further, known toner saving processing may also be performed on text areas. In addition, the operations in steps S303 to S305 may be skipped, and the color conversion processing and pseudo halftone processing with reduced toner consumption and with print quality preserved may be performed. In the color conversion processing, the toner consumption can be reduced while the print quality degradation is prevented, for example, by increasing the density of text edges and decreasing the density of areas inside texts.

Pseudo halftone processing can, for example, involve performing screening followed by a thinning process using blue noise, which is highly dispersed, irregular, and uniform. This allows toner consumption to be reduced without causing large missing portions and/or jaggies, while taking advantage of optical dot gain.

In the present exemplary embodiment, the toner consumption for the input image data is not set. However, a screen indicating print settings may be displayed on the monitor 110, allowing the user to set the toner consumption via the input device 109.

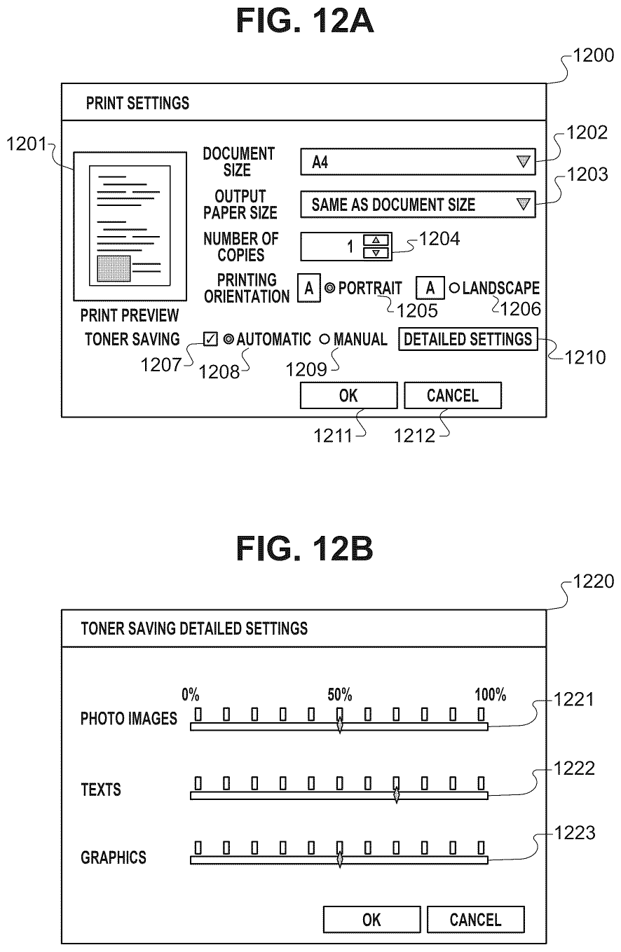

FIGS. 12A and 12B illustrate examples of screens for allowing the user to make print settings to be used when the image processing apparatus 100 performs image formation. The setting screens illustrated in FIGS. 12A and 12B may be displayed on the monitor 110 of the image processing apparatus 100 or displayed on the screen of a personal computer (PC) communicably connected to the image processing apparatus 100. The CPU 101 receives setting values set by the user in a main screen 1200 for print settings and a Toner Saving Detailed Settings screen 1220.

FIG. 12A illustrates the main screen 1200 for print settings. The main screen 1200 for print settings includes a preview area 1201, a document size setting area 1202, an output size setting area 1203, a copy number setting area 1204, and printing orientation setting areas 1205 and 1206. The main screen 1200 for print settings also includes a cancel button 1212 for canceling settings and an OK button 1211 for applying settings, which are common to the other screen.

The preview area 1201 displays a preview of the data to be printed, allowing the user to check the finish of the print product. The document size setting area 1202 displays the document size and allows the user to select the suitable document size from among the document sizes displayed in the pull-down menu. If the image processing apparatus 100 has acquired document size information, the relevant information is displayed in the document size setting area 1202.

The output size setting area 1203 is used to set the size of the print product to be output, allowing the user to select a desired size from among the output paper sizes displayed in the pull-down menu. The copy number setting area 1204 is used to set the number of copies of the print product to be output, allowing the user to set the number of copied to be printed, by pressing the arrow buttons or entering a numerical value. The print orientation setting area 1205 is used to specify the paper orientation when a print product is printed, allowing the user to select Portrait or Landscape.

A toner saving check box 1207 is used to subject the object in the print image to toner saving in printing. Checking (selecting) the check box enables toner saving, and unchecking (deselecting) the check box disables toner saving. If toner saving is enabled (checkbox is checked), the object is printed with toner saving. If toner saving is disabled (checkbox is unchecked), the object is printed without toner saving.

An Automatic button 1208 and a manual button 1209 are used to select whether detailed settings for toner saving are automatically set or manually set by the user. Either one of the buttons 1208 and 1209 is selectable if the toner saving check box 1207 is checked.

If the Automatic button 1208 is selected, the toner saving processing is performed using a threshold for setting a high toner reduction area and the color conversion LUT, which are predetermined. If the Manual button 1209 is selected, the image conversion conditions are adjusted based on the toner consumption level set with a Detailed Settings button 1210. If the Automatic button 1208 is selected, the object is printed according to the above-described method.

If the Detailed Settings button 1210 is pressed, a Toner Saving Detailed Settings screen 1220 appears.

FIG. 12B illustrates the Toner Saving Detailed Settings screen 1220. The Toner Saving Detailed Settings screen 1220 includes toner consumption setting areas 1221, 1222, and 1223. The toner consumption setting areas 1221, 1222, and 1223 allow the user to set the toner consumption for each object within a range from 0% to 100%. If the toner consumption is set by the user, in steps S305 to S309, some or all of the area segmentation unit 222, the color conversion processing unit 224, the density adjustment unit 225, and the pseudo halftone processing unit 226 change the image conversion conditions according to the toner consumption set by the user.

More specifically, in step S305, the area segmentation unit 222 adjusts the threshold for setting the high toner reduction area 701, according to the toner consumption. In step S306, the color conversion processing unit 224 generates the above-described new color conversion LUTs in ascending order of the average saliency of pixels with the same semantic label information in the low toner reduction areas, and then performs the color conversion. In step S307, the density adjustment unit 225 performs the above-described new density adjustment in ascending order of the average saliency of pixels with the same semantic label information in the low toner reduction areas. The pseudo halftone processing unit 226 performs the pseudo halftone processing based on the above-described new thinning amount in ascending order of the average saliency of pixels with the same semantic label information in the low toner reduction areas.

Changing the image conversion conditions according to the toner consumption in this way enables printing with the toner consumption intended by the user. According to the present exemplary embodiment, the image processing apparatus 100 performs image formation through the image conversion by using the C, M, Y, and K toners. However, a special color toner is also applicable, and ink may be used instead of toner.

Some or all of pieces of the above-described processing may be performed through machine learning. The above descriptions relate to an example of processing implemented through machine learning, and each process may be performed by a method other than the above-described one.

### Second Exemplary Embodiment

### <Toner Saving Processing>

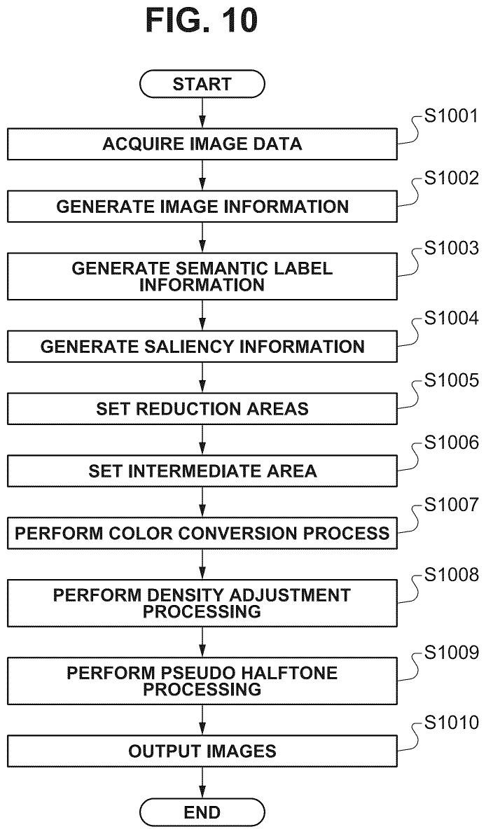

In the first exemplary embodiment, descriptions have been provided of a method for setting high and the low toner reduction areas according to the saliency (attention level) of the photo image areas to reduce the toner consumption so that the amount of toner used to draw the high toner reduction area 701 is less than the amount of toner used to draw the low toner reduction area 702. This enables, for example, reducing the toner consumption while preventing the print quality degradation. In the present exemplary embodiment, a description will be provided, with reference to FIG. 10, of a method for performing smoothing processing on the boundary between high and the low toner reduction areas to prevent the appearance of steps caused by differences in toner consumption.

Differences between the present exemplary embodiment and the above-described first exemplary embodiment will be described below. Portions not having been described in detail above are similar to portions in the first exemplary embodiment, and redundant descriptions thereof will be omitted.

Operations in steps S1001 to S1005 are similar to those in steps S301 to S305, and redundant descriptions thereof will be omitted.

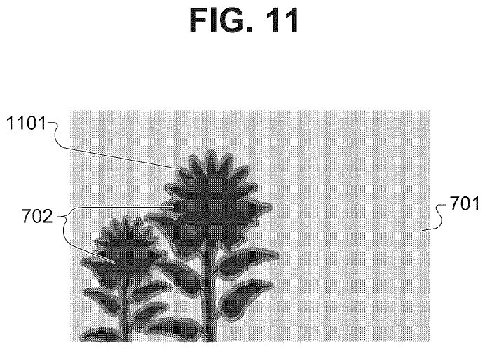

In step S1006, the area segmentation unit 222 controlled by the CPU 101 sets a buffer area 1101 as illustrated in FIG. 11 to an area in the vicinity of the boundary between the high toner reduction area 701 and a low toner reduction area 702 set in step S1005. For example, the area segmentation unit 222 sets the buffer area 1101 based on the difference between the area outwardly expanded by 10 pixels from the boundary of the low toner reduction area 702 and the low toner reduction area 702. If there is an area where the low toner reduction area 702 overlaps with the buffer area 1101, the CPU 101 sets the overlapping area as the low toner reduction area 702.

In step S1007, the color conversion processing unit 224 controlled by the CPU 101 performs the color conversion so that the amount of toner used to draw the buffer area 1101 set in step S1006 falls between the amount of toner used to draw the high toner reduction area 701 and the amount of toner used to draw the low toner reduction area 702. In this color conversion, the color conversion processing unit 224 refers to the color conversion LUTs stored in the storage unit 104 to perform the color conversion. The color conversion method is similar to that in step S306, and redundant descriptions thereof will be omitted.

In step S1008, the density adjustment unit 225 controlled by the CPU 101 performs the density adjustment so that the amount of toner used to draw the buffer area 1101 falls between the amount of toner used to draw the high toner reduction area 701 and the amount of toner used to draw the low toner reduction area 702. In this density adjustment, the density adjustment unit 225 performs the density adjustment by adjusting the CMYK signal values obtained in step S1006. The density adjustment method is similar to that in step S307, and redundant descriptions thereof will be omitted.

In step S1009, the pseudo halftone processing unit 226 controlled by the CPU 101 performs the pseudo halftone processing so that the amount of toner used to draw the buffer area 1101 falls between the amount of toner used to draw the high toner reduction area 701 and the amount of toner used to draw the low toner reduction area 702. In this pseudo halftone processing, the pseudo halftone processing unit 226 performs the pseudo halftone processing by using the CMYK signal values obtained by the density adjustment unit 225 in step S1007. The pseudo halftone processing method is similar to that in step S308, and redundant descriptions thereof will be omitted.

The operation in step S1010 is similar to that in step S308, and redundant descriptions thereof will be omitted.

Performing the smoothing processing on the boundary between high and low toner reduction areas enables preventing the appearance of steps caused by differences in toner consumption. In the above-described example according to the present exemplary embodiment, the CPU 101 performs different color conversion processing, different density adjustment processing, and different pseudo halftone processing as image processing suitable for each of the high toner reduction area 701, the low toner reduction area 702, and the buffer area 1101. However, these pieces of processing do not necessarily need to be different for each area.

For example, the color conversion processing fora high toner reduction area and a buffer area may be unified, and different density adjustment processing and different pseudo halftone processing may be performed on the two areas, as in steps S1008 and S1009.

In addition, the density adjustment processing and the pseudo halftone processing for a low toner reduction area and a buffer area may be unified, and different color conversion processing may be performed on the two areas, as in step S1007. If the amount of toner used to draw the buffer area of the printing image converted by the image conversion unit 220 falls between the amount of toner used to draw the high toner reduction area 701 and the amount of toner used to draw the low toner reduction area 702, the method is not limited thereto.

Although, in the present exemplary embodiment, the photo image areas are segmented into three different areas, specifically, a high toner reduction area, a low toner reduction area, and a buffer area, the photo image areas may be segmented into more than three areas and prevent the appearance of steps caused by differences in toner consumption.

Some or all of pieces of the above-described processing may be performed through machine learning. The above descriptions is an example of processing implemented through machine learning, and each piece of processing may be performed by a method other than the above-described one.

In the above-described processing, descriptions have been provided of a process of setting high and the low toner reduction areas according to the details of the photo image areas, thus reducing the toner consumption such that the amount of toner used to draw the high toner reduction area is less than the amount of toner used to draw the low toner reduction area. The present disclosure enables efficient reduction of the toner consumption while preventing the print quality degradation. Further, subjecting the boundary between the high and the low toner reduction areas to the smoothing processing enables reduction of the appearance of steps caused by differences in toner consumption.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-139289, filed Aug. 20, 2024, which is hereby incorporated by reference herein in its entirety.

What is claimed is:

1. An image forming apparatus comprising:
a printer;
at least one memory storing a program; and
at least one processor that, upon execution of the program is configured to:
acquire an attention level in an area of an image based on image data, the attention level being estimated through machine learning;
perform image processing on the image data based on the estimated attention level so that an amount of recording material to be used to draw an area with a low attention level in the image is less than an amount of recording material to be used to draw an area with a high attention level in the image; and
cause the printer to print the image on a printing medium based on the image data having been subjected to the image processing.

2. The image forming apparatus according to claim 1,
wherein saliency information and semantic label information are calculated through the machine learning for each pixel of the image data, and
wherein the attention level is calculated according to the calculated saliency information and the calculated semantic label information.

3. The image forming apparatus according to claim 2, wherein execution of the stored program further configures the at least one processor to perform image processing on the image data so that the amount of recording material to be used to draw the area with the low attention level is less than the amount of recording material to be used to draw the area with the high attention level.

4. The image forming apparatus according to claim 2, wherein execution of the stored program further configures the at least one processor to perform image processing on the image data so that, in a neighboring area proximate to a boundary between the area with the low attention level and the area with the high attention level, an amount of recording material to be used to draw the neighboring area included in the area with the low attention level is less than an amount of recording material to be used to draw the area with the high attention level.

5. The image forming apparatus according to claim 4, execution of the stored program further configures the at least one processor to perform image processing on the image data so that the amount of recording material to be used to draw the area with the low attention level is less than the amount of recording material to be used to draw the neighboring area.

6. The image forming apparatus according to claim 1, wherein execution of the stored program further configures the at least one processor to perform image processing on the image data by using a color conversion table.

7. The image forming apparatus according to claim 1, wherein execution of the stored program further configures the at least one processor to adjust a density by adjusting signal values of single colors.

8. The image forming apparatus according to claim 1, wherein execution of the stored program further configures the at least one processor to receive a setting of an amount of recording material to be used when the printer performs printing.

9. The image forming apparatus according to claim 1, wherein the image data includes photo image data.

10. An image processing method comprising:
acquiring an attention level in an area of an image based on image data, the attention level being estimated through machine learning;
performing image processing on the image data based on the estimated attention level so that an amount of recording material to be used to draw an area with a low attention level in the image is less than an amount of recording material to be used to draw an area with a high attention level in the image; and
printing the image on a printing medium based on the image data having been subjected to the image processing.

11. The image processing method according to claim 10,
wherein saliency information and semantic label information are calculated through the machine learning, for each pixel of the image data, and
wherein the attention level is calculated according to the calculated saliency information and the calculated semantic label information.

12. The image processing method according to claim 11, wherein the image processing is performed on the image data so that the amount of recording material to be used to draw the area with the low attention level is less than the amount of recording material to be used to draw the area with the high attention level.

13. The image processing method according to claim 11, wherein the image processing is performed on the image data so that, in a neighboring area in a vicinity of a boundary between the area with the low attention level and the area with the high attention level, an amount of recording material to be used to draw the neighboring area included in the area with the low attention level is less than an amount of recording material to be used to draw the area with the high attention level.

14. The image processing method according to claim 13, wherein the image processing is performed on the image data so that the amount of recording material to be used to draw the area with the low attention level is less than the amount of recording material to be used to draw the neighboring area.

15. The image processing method according to claim 10, wherein the image processing is performed by using a color conversion table.

16. The image processing method according to claim 10, further comprising adjusting a density by adjusting signal values of single colors.

17. The image processing method according to claim 10, further comprising receiving a setting of an amount of recording material to be used in the printing.

18. The image processing method according to claim 10, wherein the image data includes photo image data.
